(19) United States
(12) Patent Application Publication
(10) Pub. No.: US 2011/0018763 A1
(43) Pub. Date: Jan. 27, 2011

(54) Positioning apparatus, positioning method, and program product

(75) Inventors: Yuusuke Watanabe, Anjo-city (JP); Tatsuya Iwase, Aichi-gun (JP); Noriyoshi Suzuki, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/801,872

(22) Filed: Jun. 29, 2010

(30) Foreign Application Priority Data
Jul. 6, 2009 (JP) 2009-159941

(51) Int. Cl. G01S 19/23

(52) U.S. Cl. 342/357.62

(57) ABSTRACT

A GPS receiver outputs pseudo distances each containing a clock bias error. A clock bias and a reception position are calculated based on each of the outputted pseudo distances. A clock drift is calculated based on clock biases at past n points or Doppler information outputted from the GPS receiver. Based on the calculated clock drift, a reference clock bias is estimated using a regression equation or a Kalman filter. Thereby, a position-fix accuracy is evaluated appropriately, without needing external data, such as autonomous navigation information.

### CROSS REFERENCE TO RELATED APPLICATION

The present application is based on and incorporates herein by reference Japanese Patent Application No. 2009-159941 filed on Jul. 6, 2009.

### FIELD OF THE INVENTION

The present invention relates to a positioning apparatus and a positioning method for evaluating a positioning accuracy, and a related program product.

### BACKGROUND OF THE INVENTION

[Patent document 1] JP-2008-157705 A

[Patent document 2] JP-2008-139105 A

Conventionally, an in-vehicle navigation apparatus measures a position or executes positioning of a vehicle using a GPS navigation method and an autonomous navigation method. In the GPS navigation method, radio waves from several positioning satellites are received and used for measuring a reception position. In the autonomous navigation method, a position of the vehicle (i.e., subject vehicle position) is detected from a travel locus based on a distance and direction during the traveling of the vehicle.

In the positioning by the GPS navigation method, errors in positioning may arise from the various factors such as a reception environment. To that end, for instance, the following navigation system is proposed. Positioning is executed by catching and chasing several GPS satellites to thereby obtain a GPS positioning solution. A predetermined reference value is calculated based on the comparison result of outputted autonomous navigation information and GPS positioning solution. The difference of the calculated predetermined reference value and the clock offset value obtained in process of positioning is calculated. The accuracy of the GPS positioning solution is determined based on the calculated difference (for instance, refer to Patent document 1).

Further, a mobile object positioning apparatus is proposed that calculates as an evaluation value an angle formed by a velocity vector of the mobile object obtained from the Doppler frequency and a shift vector indicating a movement amount of the mobile object obtained based on the result of positioning the mobile object, and determines anomalies of positioning based on the calculated evaluation value (for instance, refer to Patent document 2).

Here, the navigation system described in Patent document 1 needs the autonomous navigation system in order to evaluate the accuracy of positioning, which poses a disadvantage that the position-fix accuracy cannot be evaluated using the GPS navigation system alone. Further, in the navigation system described in Patent document 1, although the average value of several clock offset values obtained in the past is used for evaluating the position-fix accuracy, a drift component which changes over time contained in the clock offset value is not taken into consideration, which poses a disadvantage that suitable evaluation cannot be carried out.

In addition, in the mobile object positioning apparatus described in Patent document 2, the angle formed by the velocity vector of the mobile object and the shift vector of the mobile object is used as an evaluation value; thus, when the velocity of the mobile object becomes zero, the angle used as an evaluation value cannot be calculated. This poses a disadvantage that the anomaly determination cannot be carried out.

### SUMMARY OF THE INVENTION

The present invention is made so as to address the above disadvantages. It is an object to provide a positioning apparatus and a positioning method that can suitably evaluate a position-fix accuracy without needing external data such as autonomous navigation information, and a related program product.

In order to achieve the above object, according to an example of the present invention, a positioning apparatus is provided as follows. A positioning section is configured to calculate a clock bias and a reception position from a pseudo distance outputted from a GPS receiver based on satellite signals from several different satellites for positioning. Here, the pseudo distance containing a clock bias error, and the pseudo distance being from each of the satellites to the reception position. A clock drift calculation section is configured to calculate a clock drift, which indicates a ratio of a time-lapse change in the clock bias based on a plurality of clock biases calculated in a past or Doppler information outputted from the GPS receiver. A clock bias estimation section is configured to estimate a reference clock bias based on a clock drift calculated by the clock drift calculation section. An evaluation value calculation section is configured to calculate an evaluation value for evaluating a calculation accuracy of a reception position calculated by the positioning section based on a difference between a clock bias calculated by the positioning section and a reference clock bias estimated by the clock bias estimation section.

As an example of the present invention, a positioning method is provided with the following: calculating a clock bias and a reception position from a pseudo distance outputted from a GPS receiver based on satellite signals from several different satellites for positioning, the pseudo distance containing a clock bias error, the pseudo distance being from each of the satellites to the reception signal; calculating a clock drift, which indicates a ratio of a time-lapse change in the clock bias based on a plurality of clock biases calculated in a past or Doppler information outputted from the GPS receiver; estimating a reference clock bias based on the calculated clock drift; and calculating an evaluation value for evaluating a calculation accuracy of the reception position based on a difference between the calculated clock bias and the estimated reference clock bias.

Relating to this example, as yet another example of the present invention, a program product is provided to be stored in a computer readable storage medium comprising instructions for execution by a computer, the instructions including the above method for positioning, the method being computer-implemented.

According to the above-mentioned positioning apparatus, the positioning method, and the related program product, the following effect is provided in common. For example, with respect to the positioning apparatus, the GPS receiver receives satellite signals transmitted from the several different positioning satellites. The GPS receiver outputs pseudo distances, which are calculated based on the received satellite signals and contain the clock bias errors from the respective positioning satellites. The positioning section calculates a clock bias and a reception position based on those pseudo distances. The calculated clock bias includes an error arising from various factors. Thus, the clock drift calculation section calculates a clock drift, which indicates a ratio of a time-lapse change in the clock bias based on several clock biases calculated in the past or Doppler information outputted from the GPS receiver. The clock bias estimation section estimates a reference clock bias using the clock drift calculated by the clock drift calculation section. It is noted that the reference clock bias is estimated based on the clock drift; thus, the estimated value of the clock bias is considered in respect of the drift component. The evaluation value calculation section then calculates an evaluation value for evaluating the calculation accuracy of the reception position for the positioning section based on the difference between (i) the clock bias calculated by the positioning section and (ii) the reference clock bias estimated by the clock bias estimation section.

As explained above, the clock drift is calculated based on the Doppler information outputted from the GPS receiver or the clock biases at past n points; thereby, the reference clock bias is estimated. Such a configuration eliminates a need of the external data, such as autonomous navigation information, when estimating the reference clock bias in consideration of the drift component. Based on the difference between the reference clock bias and the calculated clock bias, the evaluation value which can evaluate the calculation accuracy of the reception position appropriately is computable.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram illustrating an outline of a positioning apparatus according to a first embodiment of the present invention;

FIG. 2 is a flowchart illustrating a routine of a positioning process according to the first embodiment;

FIG. 3 is a flowchart illustrating a routine of a position-fix evaluation process according to the first embodiment;

FIG. 4 is a flowchart illustrating a routine of a positioning optimization process according to the first embodiment;

FIGS. 5A and 5B are graphs illustrating time series data of Positioning error e and Evaluation value E×Light velocity c;

FIG. 6 is a diagram illustrating a relation between Positioning error e and Evaluation value E×Light velocity c;

FIG. 7 is a flowchart illustrating another example of a routine of a positioning optimization process according to the present embodiment;

FIG. 8 is a block diagram illustrating an outline of a positioning apparatus according to a second embodiment of the present invention;

FIG. 9 is a flowchart illustrating a routine of a position-fix evaluation process according to the second embodiment; and

FIG. 10 is a flowchart illustrating a routine of an initial Kalman filter value reset process according to the second embodiment.

### DETAILED DESCRIPTION OF THE PREFERRED EMBODIMENTS

Hereinafter, with reference to drawings, embodiments of the present invention are explained in detail.

In the following embodiments, the positioning apparatus is mounted in a vehicle.

### First Embodiment

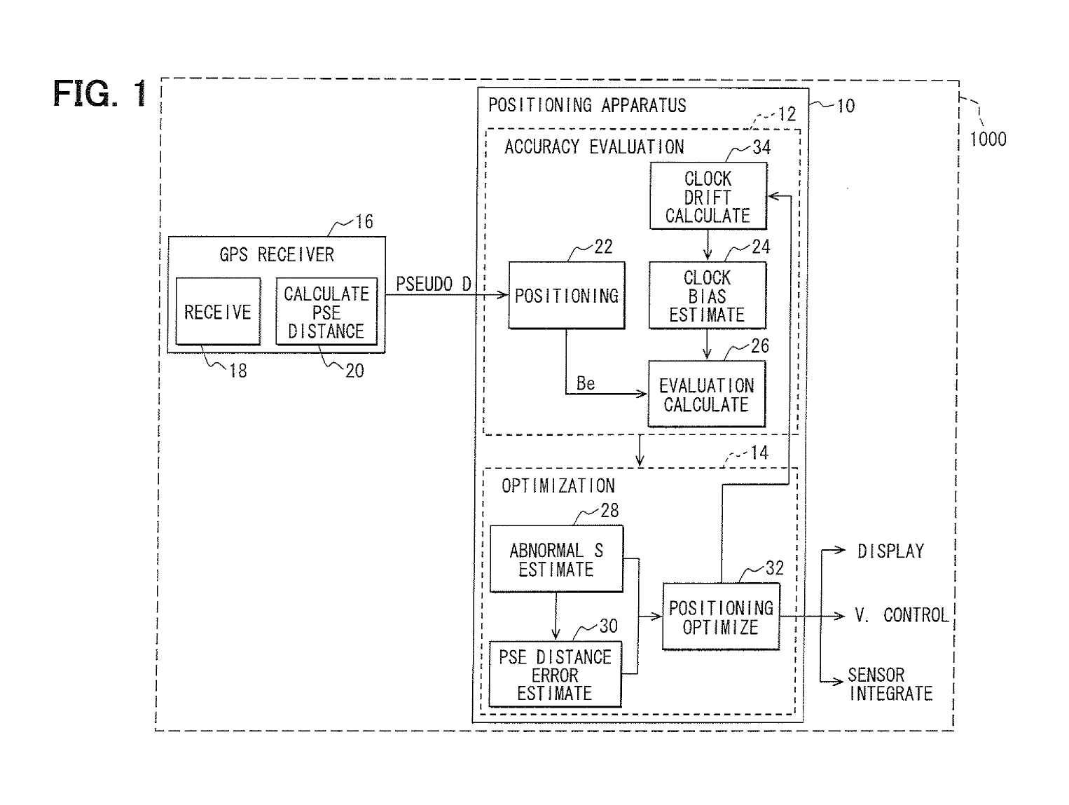

A block diagram illustrating a configuration of a positioning apparatus 10 according to a first embodiment of the present invention is shown in FIG. 1. In addition, FIG. 1 illustrates a GPS use positioning system 1000 containing the positioning apparatus 10 and a GPS receiver 16 to be mentioned later.

The positioning apparatus 10 according to the first embodiment is composed of a CPU which manages overall control of the positioning apparatus 10; a ROM as a storage medium which stores a program for a positioning process to be mentioned later; a RAM which carries out temporary storage of data as a work area; and a bus which connects the foregoing with each other. In such a configuration, a program for realizing functions of components is stored in a storage medium such as a ROM or a HDD; the CPU executes the program to thereby achieve each function.

In other words, the positioning apparatus 10 can be also referred to as a positioning circuit 10 or control circuit 10. The following explains the control circuit 10 using functional blocks indicating function realization means into which the function of the control circuit 10 is divided based on the hardware sections and software sections. As illustrated in FIG. 1, the control circuit 10 includes a position-fix accuracy evaluation section 12 which evaluates a position-fix accuracy of a reception position (vehicle position), and an optimization section 14 which optimizes a positioning result and outputs an optimal positioning value. The position-fix accuracy evaluation section 12 includes several sections; thus, it may be also referred to as a position-fix accuracy evaluation group 12. Furthermore, the position-fix accuracy evaluation section 12 includes a positioning section 22 which carries out positioning of a reception position based on a pseudo distance outputted from a GPS receiver 16; a clock drift calculation section 34 which calculates a clock drift based on a past clock bias; a clock bias estimation section 24 which estimates a present reference clock bias using a clock drift calculated in the clock drift calculation section 34; and an evaluation value calculation section 26 which calculates an evaluation value of position-fix accuracy based on (i) a clock bias calculated when positioning of the reception position is made by the positioning section 22, and (ii) a reference clock bias estimated in the clock bias estimation section 24. Further, the optimization section 14 includes several sections; thus, it may be also referred to as an optimization group 14. The optimization section 14 includes an anomaly signal estimation section 28 which estimates whether a satellite signal corresponding to an inputted pseudo distance is normal or abnormal; a pseudo distance error estimation section 30 which estimates a pseudo distance error based on an estimation result of the anomaly signal estimation section 28; and a positioning optimization section 32 which outputs an optimal positioning value based on an estimation result of the anomaly signal estimation section 28 or the pseudo distance error estimation section 30.

Furthermore, each section may be also referred to as a means. In addition, the control circuit 10 serving as the positioning apparatus 10 includes each section or each means; it may be said that the control circuit 10 functions as each section or each means.

The GPS receiver 16 includes a reception section 18 and a pseudo distance calculation section 20. The reception section 18 receives satellite signals transmitted from the positioning satellites. Based on the received satellite signals, the pseudo distance calculation section 20 calculates pseudo distances between the respective positioning satellites and the reception position. The calculated pseudo distances are outputted to the positioning apparatus 10. Each pseudo distance contains a clock bias error converted into a distance. The error (clock bias error) is produced between (i) a GPS clock time and (ii) a clock time indicated by a clock of the GPS receiver 16, because of gaining (losing) of the clock of the GPS receiver 16.

The positioning section 22 carries out positioning of the reception position of the satellite signals using four or more pseudo distances outputted from the GPS receiver 16. As explained above, the clock bias error is included in each pseudo distance; thus, the clock bias Be is also calculated at a time of positioning by the positioning section 22. It is noted that, as explained above, the clock bias is an error produced between a GPS clock time and a clock time indicated by the clock of the GPS receiver 16; the clock bias is a value containing a drift component (clock drift) which changes over time.

The clock drift calculation section 34 calculates a clock drift D based on a clock bias obtained in the past from the positioning optimization process, which is to be mentioned later.

The clock bias estimation section 24 estimates a reference clock bias Bs using the calculated clock drift D. The reference clock bias Bs is estimated using the clock drift D; thus, the reference clock bias Bs is a value in which the drift component is already considered.

The evaluation value calculation section 26 calculates an evaluation value of the position-fix accuracy based on a difference between (i) a clock bias Be calculated when positioning of the reception position is made by the positioning section 22, and (ii) a reference clock bias Bs estimated by the clock bias estimation section 24.

The anomaly signal estimation section 28 enumerates all the combinations in which four or more pseudo distances are selected from those used for the positioning of the reception position, and calculates a positioning error obtained from an evaluation value of the position-fix accuracy with respect to each of the combinations. The anomaly signal estimation section 28 then estimates that respective satellite signals corresponding to the pseudo distances of the combination having a minimum positioning error are normal and that respective satellite signals corresponding to pseudo distances not included in the combination having the minimum positioning error are abnormal.

The pseudo distance error estimation section 30 estimates that a pseudo distance error is a difference between (i) a distance from the reception position to the satellite, the distance which is calculated based on a pseudo distance of the combination having the minimum positioning error and (ii) a distance from the reception position to the satellite, the distance which is calculated based on a pseudo distance used for the positioning (a pseudo distance corresponding to the satellite signals estimated to be abnormal is included).

The positioning optimization section 32 defines as an optimal positioning value a positioning value calculated based on the pseudo distances in the combination having the minimum positioning error obtained by the anomaly signal estimation section 28, and outputs the optimal positioning value along with the information on the positioning error. Alternatively, the positioning optimization section 32 defines as an optimal positioning value a positioning value which have undergone the amendment based on the pseudo distance error estimated by the pseudo distance error estimation section 30, and outputs the optimal positioning value along with the information on the positioning error. The outputted optimal positioning value and positioning error information are inputted to a display apparatus for displaying a positioning result and used for a navigation system; inputted to a vehicle control section and used for an automatic control of the vehicle; or inputted to a sensor integration apparatus to be integrated with a measuring result of a sensor other than the GPS, and used for a position-fix accuracy improvement. In addition, so as to be used for the calculation of the clock drift in the clock drift calculation section 34, the clock bias Be, which is obtained when the positioning value serving as the optimal positioning value is calculated, is stored in a predetermined storage region.

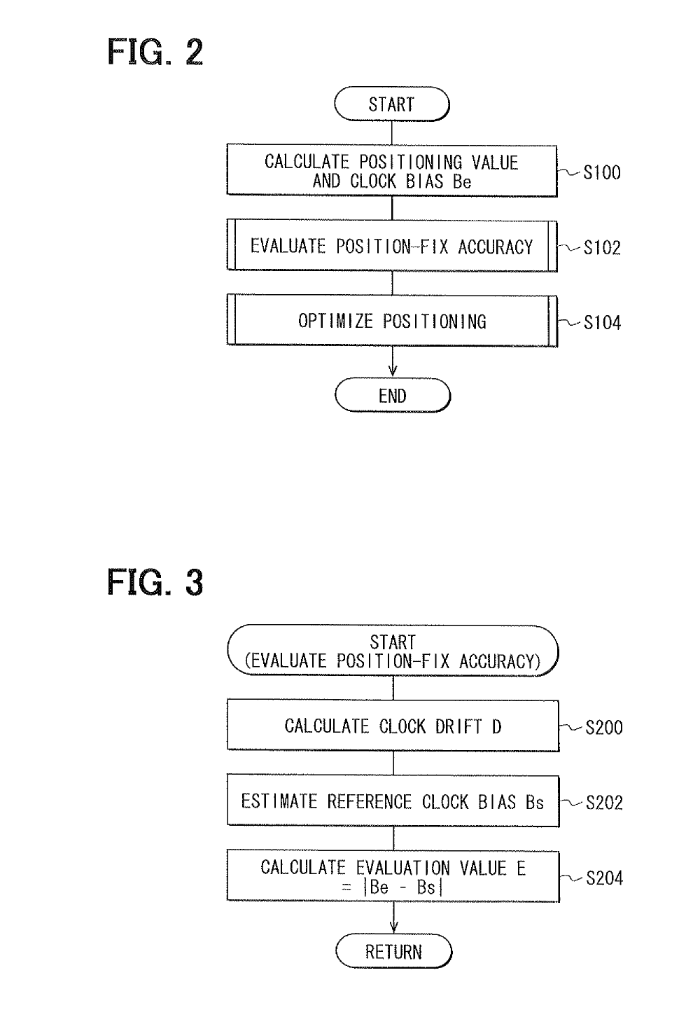

With reference to FIG. 2, the following explains a routine of a positioning process by the positioning apparatus 10 according to the first embodiment.

It is noted that a flowchart or the processing of the flowchart in the present application includes sections (also referred to as steps), which are represented, for instance, as S100. Further, each section can be divided into several sub-sections while several sections can be combined into a single section. Furthermore, each of thus configured sections can be referred to as a means and achieved not only as a software section but also as a hardware section.

At S100, the positioning apparatus or the control circuit 10 calculates a positioning value of a reception position and a clock bias Be based on several pseudo distances outputted from the GPS receiver 16. A pseudo distance Ri of a satellite i is represented by Expression (1). Here, position coordinates of the satellite i are represented by (xi, yi, zi); an initial value of estimated position coordinates of the GPS receiver 16 is represented by (x0, y0, z0); true position coordinates of the GPS receiver 16 intended to obtain are represented by (xp, yp, zp); an initial value of an estimated clock bias of the GPS receiver 16 is represented by B0; and a clock bias of the satellite i is represented by bi.

[Expression (1)]

Rᵢ=\sqrt{(xᵢ−xₚ)²+(yᵢ−yₚ)²+(zᵢ−zₚ)²}+Be+bi (1)

In addition, when a difference between the true position coordinates and the estimated value of the GPS receiver 16 is defined as Δ, Expression (2) is obtained.

$$\begin{matrix}[ Expression ( 2 ) ] & \\ \begin{matrix}{x}_{p} = {x}_{0} + Δ x \\ {y}_{p} = {y}_{0} + Δ y \\ {z}_{p} = {z}_{0} + Δ z \\ Be = {B}_{0} + Δ B\end{matrix} \} & ( 2 )\end{matrix}$$

When Expression (1) is linearized by Expression (2), Expression (3) is obtained.

$$\begin{matrix}[ Expression ( 3 ) ] & \\ Δ {R}_{i} = \frac{\partial {R}_{i}}{\partial x} Δ x + \frac{\partial {R}_{i}}{\partial y} Δ y + \frac{\partial {R}_{i}}{\partial z} Δ z + Δ B \\ \begin{matrix}\frac{\partial {R}_{i}}{\partial x} = \frac{- ( {x}_{i} - {x}_{0} )}{\sqrt{{( {x}_{i} - {x}_{0} )}^{2} + {( {y}_{i} - {y}_{0} )}^{2} + {( {z}_{i} - {z}_{0} )}^{2}}} = {α}_{i} \\ \frac{\partial {R}_{i}}{\partial y} = \frac{- ( {y}_{i} - {y}_{0} )}{\sqrt{{( {x}_{i} - {x}_{0} )}^{2} + {( {y}_{i} - {y}_{0} )}^{2} + {( {z}_{i} - {z}_{0} )}^{2}}} = {β}_{i} \\ \frac{\partial {R}_{i}}{\partial z} = \frac{- ( {z}_{i} - {z}_{0} )}{\sqrt{{( {x}_{i} - {x}_{0} )}^{2} + {( {y}_{i} - {y}_{0} )}^{2} + {( {z}_{i} - {z}_{0} )}^{2}}} = {γ}_{i}\end{matrix} \} & ( 3 )\end{matrix}$$

When Expression (3) is written by matrix representation with respect to all the satellites, Expression (4) is obtained. When replacing by Expression (5), Expression (6) is obtained.

$$\begin{matrix}[ Expressions ( 4 ) to ( 6 ) ] & \\ ( \begin{matrix}Δ {R}_{1} \\ Δ {R}_{2} \\ ⋮ \\ Δ {R}_{m}\end{matrix} ) = ( \begin{matrix}{α}_{1} & {β}_{1} & {γ}_{1} & 1 \\ {α}_{2} & {β}_{2} & {γ}_{2} & 1 \\ ⋮ & ⋮ & ⋮ & ⋮ \\ {α}_{m} & {β}_{m} & {γ}_{m} & 1\end{matrix} ) ( \begin{matrix}Δ x \\ Δ y \\ Δ z \\ Δ B\end{matrix} ) & ( 4 ) \\ A = ( \begin{matrix}{α}_{1} & {β}_{1} & {γ}_{1} & 1 \\ {α}_{2} & {β}_{2} & {γ}_{2} & 1 \\ ⋮ & ⋮ & ⋮ & ⋮ \\ {α}_{m} & {β}_{m} & {γ}_{m} & 1\end{matrix} ) Δ R = ( \begin{matrix}Δ {R}_{1} \\ Δ {R}_{2} \\ ⋮ \\ Δ {R}_{m}\end{matrix} ) Δ X = ( \begin{matrix}Δ x \\ Δ y \\ Δ z \\ Δ B\end{matrix} ) & ( 5 ) \\ Δ R = A Δ X & ( 6 )\end{matrix}$$

In the case of m>4, the number of expressions increases compared with the number of variables to search for, thereby producing an overdetermination state. The solution is obtained so as to follow restrictions of m pieces expressions as much as possible using the least-squares method. This can be obtained as Expression (7).

[Expression (7)]

ΔX=(A^{T}A)⁻¹A^{T}ΔR (7)

Expression (2) is updated using ΔX obtained from Expression (7), and repeatedly calculated up to a time when an estimated value converges. Thus, the positioning value of the reception position and the clock bias Be are computable.

Next, at S102, a position-fix accuracy evaluation process, which is to be mentioned later, is executed. Next, at S104, a positioning optimization process, which is to be also mentioned later, is executed. The present process is then ended.

With reference to FIG. 3, the following explains a routine of a position-fix accuracy evaluation process executed at S102 of the positioning process in FIG. 2.

At S200, the clock drift D is calculated based on Expression (8) using n points clock biases, which are clock biases obtained at past n points and stored in a predetermined storage region.

$$\begin{matrix}[ Expression ( 8 ) ] & \\ D = \frac{( \vec{B} e - \overline{B} e ) \times {( \vec{t} - \overline{t} )}^{′}}{( \vec{t} - \overline{t} ) \times {( \vec{t} - \overline{t} )}^{′}} & ( 8 )\end{matrix}$$

\vec{B}e: Past n points clock biases value vector

B̅e: Average of Past n points biases value vector

\vec{t}: Clock vector corresponding to Past n points

t̅: Average of Clock vector corresponding to Past n points

( )′: Transposed vector

Next, at S202, the value of the clock drift D calculated by Expression (8) is substituted to the regression equation of Expression (9); thus, the reference clock bias Bs is estimated.

[Expression (9)]

Bs=(D×t)+Be₀ (9)

Here, Be₀ is a value of the clock bias at clock time t=0. That is, the reference clock bias Bs at clock time t can be estimated by Expression (9).

Next, at S204, a difference between the clock bias Be calculated at S100 of the above positioning process (FIG. 2) and the reference clock bias Bs estimated at S202 is calculated as an evaluation value E (E=|Be−Bs|). The processing is returned.

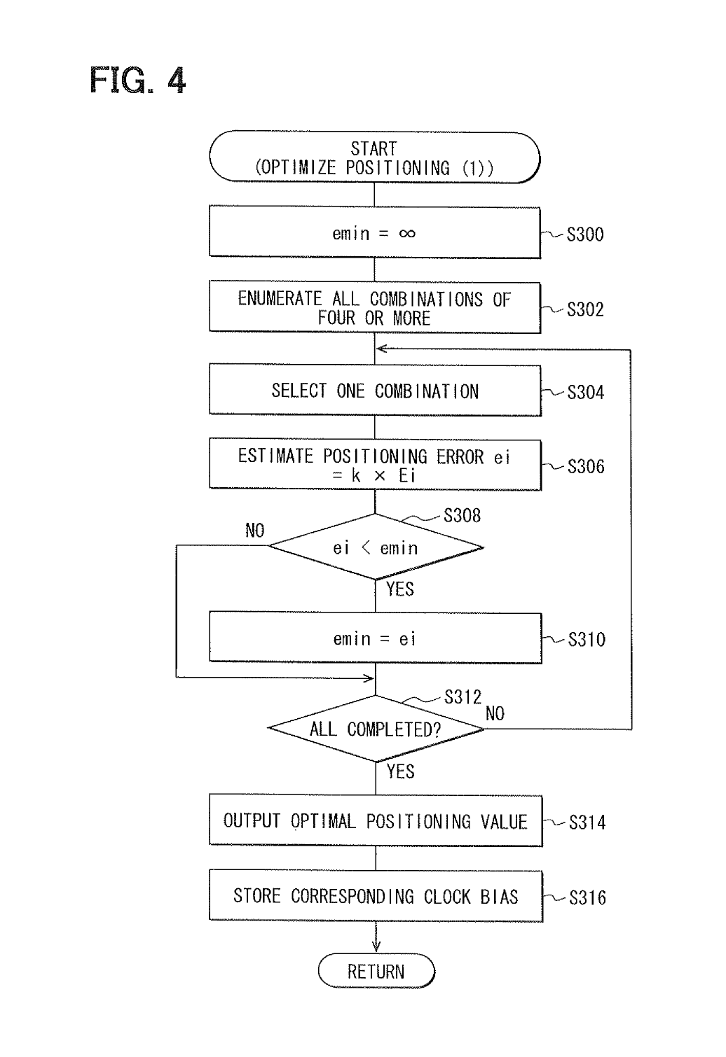

With reference to FIG. 4, the following explains a routine of a positioning optimization process executed at S104 of the positioning process in FIG. 2.

At S300, ∞ is set to the variable emin which indicates the minimum positioning error. Next, at S302, all combinations are enumerated, all the combinations each of which selects four or more pseudo distances out of the pseudo distances, which were used for positioning. Next, at S304, one combination i (i=1, 2, . . . , n, n is the total number of all the combinations) is selected from the enumerated combinations.

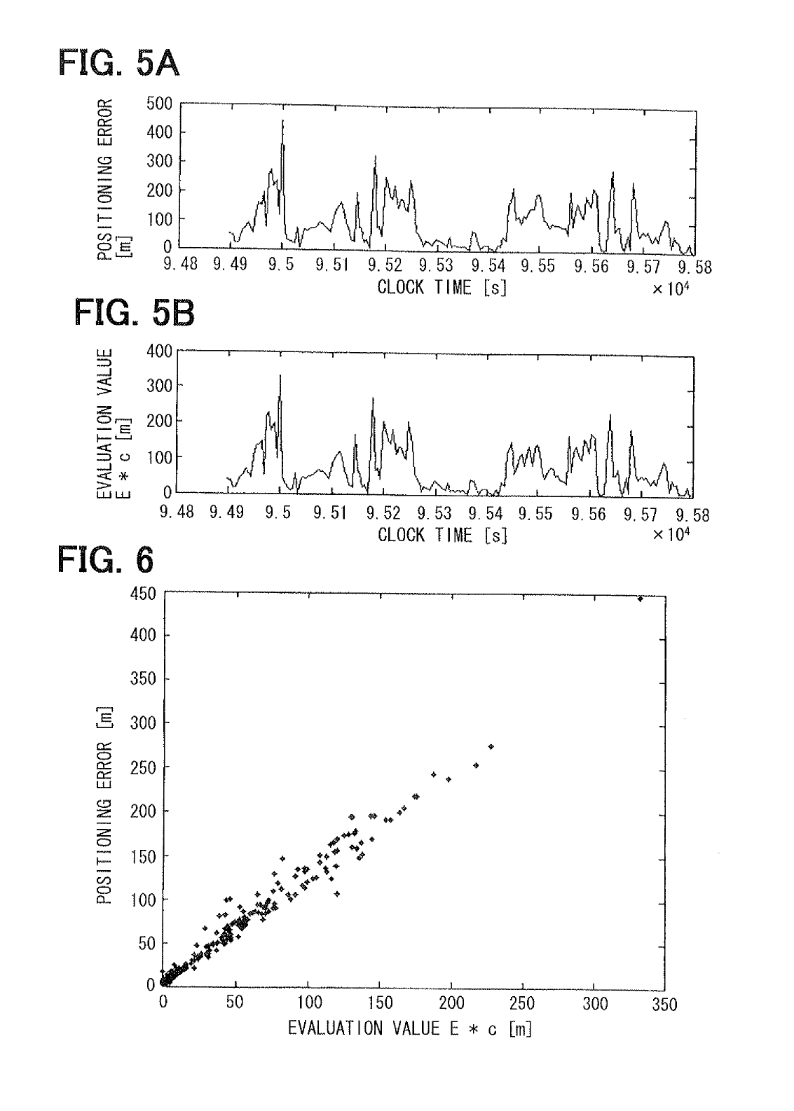

Next, at S306, with respect to the combination i selected at S304, a positioning error ei is estimated. It is noted that the evaluation value E and the positioning error e turn out to have a correlation as indicated in FIG. 5A, FIG. 5B, and FIG. 6. Based on such a correlation, the positioning error e can be estimated by Expression (10).

[Expression (10)]

e=k×E (10)

Here, k is a coefficient. The correlation from FIGS. 5A, 5B, 6 allows the setting of k=0.8, for instance. In addition, in order to estimate the positioning error ei about combination i, the evaluation value E turns into the evaluation value Ei calculated based on the pseudo distance of combination i.

Next, at S308, it is determined whether the positioning error ei is less than the variable emin. When ei<emin, the processing proceeds to S310, where the value of the variable emin is replaced with the value of ei. The processing then proceeds to S312. In contrast, when ei>=emin, the processing proceeds directly to S312. At S312, it is determined whether a process in which the positioning error e is estimated and compared with the emin is completed with all the combinations. When it is completed, the processing proceeds to S314. When it is not completed, the processing returns to S304 to select the next combination and repeat the corresponding process.

At S314, the positioning error ei used as the variable emin is regarded as the minimum positioning error; the positioning value calculated based on the pseudo distances of the combination i corresponding to the positioning error ei is outputted as an optimal positioning value.

Next, at S316, in order to use the value of the clock bias. which is obtained when calculating the positioning value based on the pseudo distances of the combination i, for the calculation of the clock drift, the value of the clock bias is stored in a predetermined storage region. The processing is then returned.

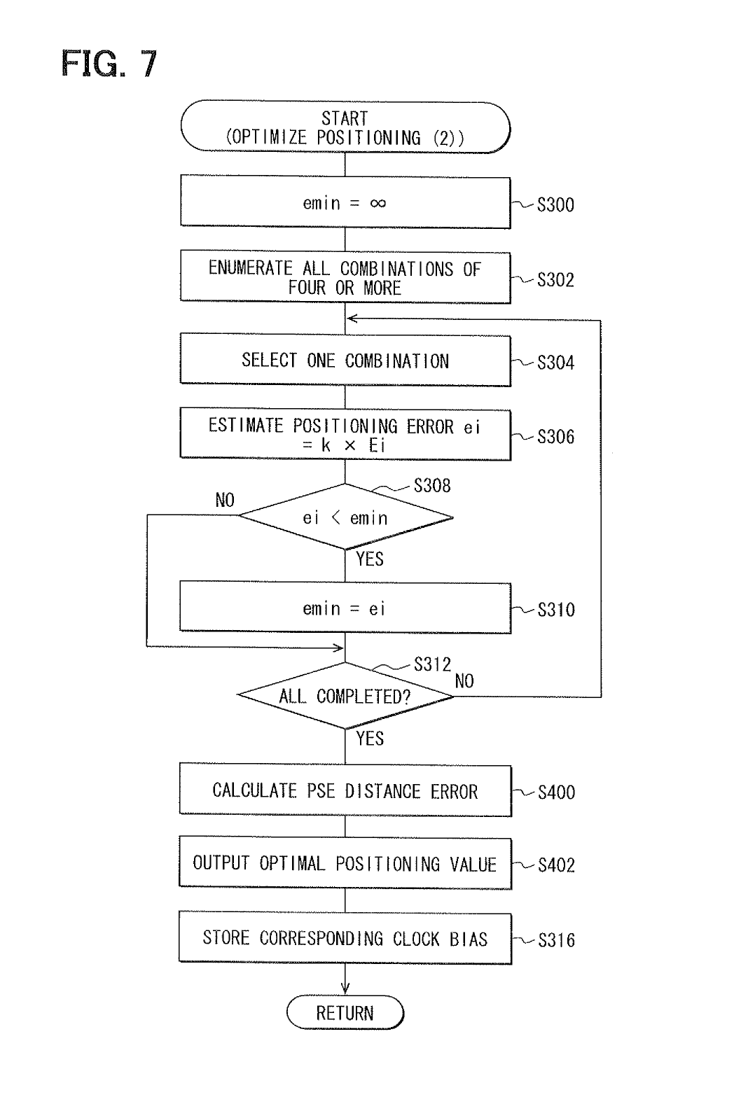

With reference to FIG. 7, the following explains a routine of the positioning optimization process (2) which is another example of the positioning optimization process. The processing of S300 to S312 is the same as that of the positioning optimization process (1) mentioned above; thus, explanation is omitted.

At S400, a pseudo distance error is estimated which is a difference between (i) a distance from the reception position to the satellite, the distance which is calculated based on the pseudo distances of the combination i and (ii) a distance from the reception position to the satellite, the distance which is calculated based on the pseudo distances used for the positioning. The reception position calculated based on the pseudo distances used for the positioning is the reception position of the positioning value calculated at S100 of the positioning process (FIG. 2).

Next, at S402, based on the pseudo distance error estimated at above S400, the positioning value calculated at S100 of the positioning process (FIG. 2) is amended, and the positioning value posterior to the amendment is outputted as an optimal positioning value.

It is noted that both or one of the positioning optimization processes (1), (2) may be executed. In addition, when selecting one of the two processes, either can be selected, for example, according to the value of the minimum positioning error.

As explained above, according to the positioning apparatus of the first embodiment, the clock drift is calculated using the past clock biases; the reference clock bias is estimated; and the difference between the clock bias calculated at a time of positioning and the reference clock bias estimated at the time of positioning is used as an evaluation value of the position-fix accuracy. This can suitably calculate an evaluation value in consideration of the drift component of the clock bias without needs of external data, such as autonomous navigation information.

The first embodiment explains the case where the reference clock bias is estimated using the calculated clock drift based on the regression equation. It may not be limited thereto. That is, the reference clock bias may be estimated using the calculated clock drift by a sequential estimation, such as the Kalman filter or particle filter.

### Second Embodiment

Next, the positioning apparatus according to a second embodiment of the present invention is explained. The positioning apparatus according to the second embodiment differs from the positioning apparatus 10 according to the first embodiment in a calculation method of a clock drift which is used to estimate a reference clock bias. The same configuration and processing as those of the positioning apparatus 10 according to the first embodiment are assigned with identical reference numbers and omitted from the explanation.

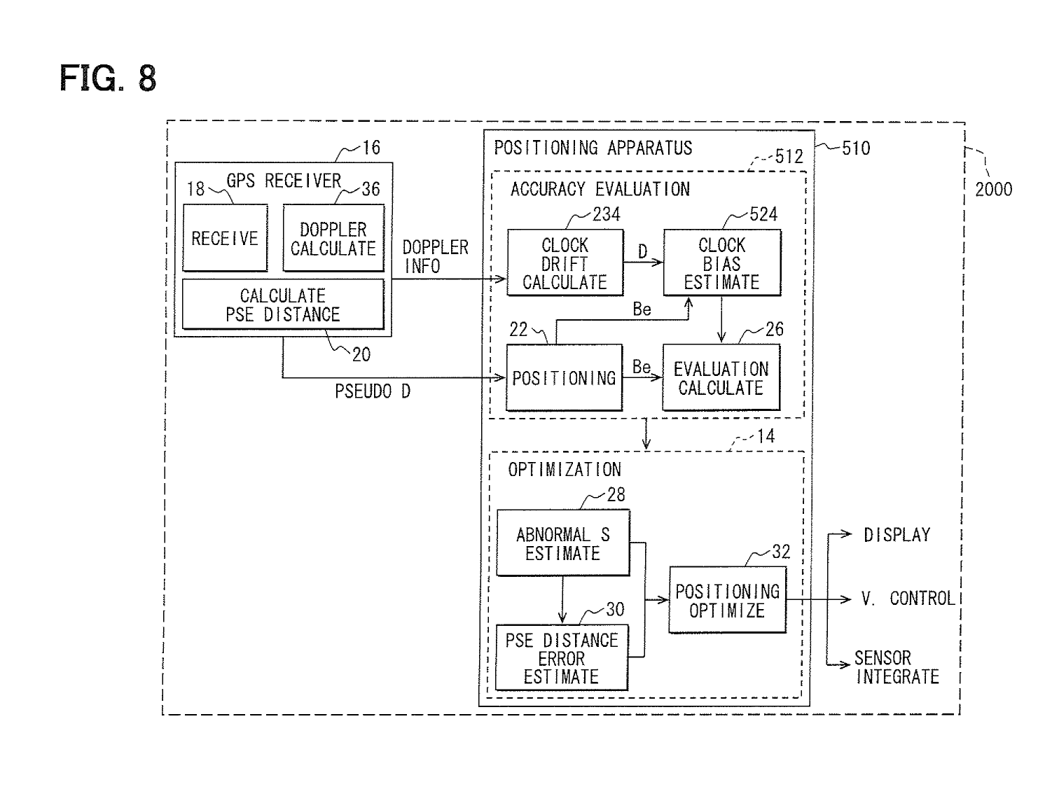

FIG. 8 is a block diagram illustrating a configuration of a positioning apparatus 510 according to the second embodiment of the present invention. In addition, FIG. 8 illustrates a GPS use positioning system 2000 containing the positioning apparatus 510 and the GPS receiver 16, like the first embodiment.

The positioning apparatus 510 according to the second embodiment is composed of a CPU which manages overall control of the positioning apparatus 510; a ROM as a storage medium which stores a program for a positioning process to be mentioned later; a RAM which carries out temporary storage of data as a work area; and a bus which connects the foregoing with each other. In such a configuration, a program for realizing functions of components is stored in a storage media such as a ROM or a HDD; the CPU execute the program to thereby achieve each function.

The positioning apparatus 510 can be also referred to as a positioning circuit 510 or control circuit 510. The following explains the control circuit 510 using functional blocks indicating function realization means into which the function of the control circuit 510 is divided based on the hardware sections and software sections. As illustrated in FIG. 8, a position-fix accuracy evaluation section 512 which evaluates a position-fix accuracy of a reception position (vehicle position), and an optimization section 514 which optimizes a positioning result and outputs an optimal positioning value. The position-fix accuracy evaluation section 512 includes several sections; thus, it may be also referred to as a position-fix accuracy evaluation group 512. Furthermore, the position-fix accuracy evaluation section 512 includes a positioning section 22 which carries out positioning of a reception position based on a pseudo distance outputted from a GPS receiver 16; a clock drift calculation section 234 which calculates a clock drift based on Doppler information outputted from the GPS receiver 16; a clock bias estimation section 524 which estimates a present reference clock bias using a clock drift calculated in the clock drift calculation section 234; and an evaluation value calculation section 26 which calculates an evaluation value of position-fix accuracy based on (i) a clock bias calculated when positioning of the reception position is made by the positioning section 22, and (ii) a reference clock bias estimated in the clock bias estimation section 524. In addition, the optimization section 14 can be illustrated as the same configuration as that of the optimization section 14 of the positioning apparatus 10 of the first embodiment.

Furthermore, each section may be also referred to as a means like the first embodiment. In addition, the control circuit 510 serving as the positioning apparatus 510 includes each section or each means; it may be said that the control circuit 510 functions as each section or each means.

The GPS receiver 16 outputs not only pseudo distances calculated in the pseudo distance calculation section 20, but also Doppler information. The Doppler information is calculated by the Doppler information calculation section 36 based on (i) the satellite signals, which are transmitted from the positioning satellites and received by the reception section 18, and (ii) the received frequencies.

The clock drift calculation section 234 calculates a clock drift De based on the Doppler information outputted from the GPS receiver 16.

The clock bias estimation section 524 estimates a reference clock bias Bs using the Kalman filter from (i) the clock drift De calculated by the clock drift calculation section 234 and (ii) the clock bias Be calculated by the positioning section 22. The reference clock bias Bs is estimated using the clock drift D; thus, the reference clock bias Bs is a value in which the drift component is already considered.

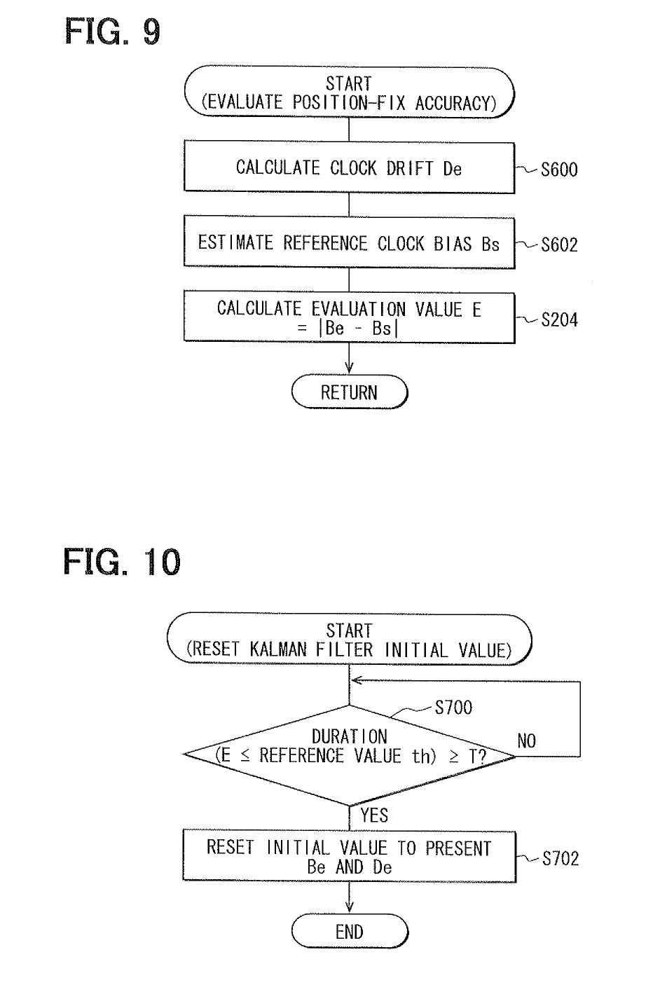

With reference to FIG. 9, the following explains a routine of a position-fix accuracy evaluation process according to the second embodiment executed at S102 of the positioning process in FIG. 2.

At S600, a clock drift De is calculated based on the Doppler information outputted from the GPS receiver 16.

The relation of the Doppler shift of the satellite i with the velocity vi of the satellite i and the velocity of the GPS receiver 16 can be represented by Expression (11) using the clock drift De.

[Expression (11)]

\dot{R}ᵢ=(vᵢ−v)lᵢ+De (11)

\dot{R}ᵢ Doppler shift of satellite i

vᵢ Velocity vector of satellite i vᵢ=(\dot{x}ᵢ,\dot{y}ᵢ,żᵢ)

v Velocity vector of GPS receiver v=(\dot{x},\dot{y},ż)

lᵢ Unit vector of satellite i directed from GPS receiver

Expression (11) is modified to obtain Expression (12).

Further, using A in Expression (5), and Expression (13), Expression (14) is obtained.

$$\begin{matrix}[ Expression ( 12 ) to ( 14 ) ] & \\ \begin{matrix}{\dot{\tilde{R}}}_{i} = - liv + De \\ {\dot{\tilde{R}}}_{i} = {\dot{R}}_{i} - vili\end{matrix} \} & ( 12 ) \\ \dot{R} = ( \begin{matrix}{\dot{\tilde{R}}}_{1} \\ ⋮ \\ {\dot{\tilde{R}}}_{m}\end{matrix} ) V = ( \begin{matrix}\dot{x} \\ \dot{y} \\ \dot{z} \\ De\end{matrix} ) & ( 13 ) \\ \dot{R} = AV & ( 14 )\end{matrix}$$

In the case of m>4, the number of expressions increases compared with the number of variables to search for, thereby producing an overdetermination state. The solution is obtained so as to follow restrictions of m pieces expressions as much as possible using the least-squares method. This can be obtained by Expression (15).

[Expression (15)]

V=(A^{T}A)⁻¹A^{T}\dot{R} (15)

By obtaining V from Expression (15), the clock drift De is computable.

Next, at S602, the reference clock bias Bs is estimated using the Kalman filter which is indicated by the configuration of Expressions (16) to (21).

[Expressions (16) to (21)]

Initial Values

Bs(0)=Be(0) (16)

Ds(0)=De(0) (17)

State Equation

Bs(t+1)=Bs(t)+Ds(t)×Δt (18)

Ds(t+1)=Ds(t)+\dot{D}s(t)×Δt (19)

\dot{D}s(t+1)=N(0,w) (20)

\dot{D}s Derivative value of reference clock drift

Observation Equation

De(t)=Ds(t)+N(0,v) (21)

Here, t is a clock time, Δt is a sampling time used as a unit of clock time, Be is a clock bias calculated at S100 of the positioning process (FIG. 2), and De is a clock drift calculated at S600.

The reference clock bias Bs is an integration value of the drift component of the reference clock bias Bs (reference clock drift Ds, which is a value obtained by subtracting a noise component from the clock drift De). The reference clock bias Bs (t+1), which is the reference clock bias at the clock time (t+1) is represented by Expression (18). The reference clock drift Ds is calculated by removing the noise from the clock drift De calculated at S600 by Expression (21). Here, N (0, v) of Expression (21) indicates a normal distribution with an average of 0 and a standard deviation of v. A derivative value of the calculated reference clock drift Ds is represented by a normal distribution with an average of 0 and a standard deviation of w as indicated by Expression (20). The reference clock drift Ds (t+1), which is the reference clock drift at the clock time (t+1) is represented by Expression (19). That is, the clock bias Be in the clock time t=0 and the clock drift De are given as initial values (see Expressions (16), (17)). The reference clock bias Bs at the clock time t can be thereby estimated using the calculated reference clock drift Ds.

Next, at S204, a difference between (i) the clock bias Be calculated at S100 of the above positioning process (FIG. 2) and (ii) the reference clock bias Bs estimated at S602 is calculated as an evaluation value E (E=|Be−Bs|). The processing is then returned.

The clock bias Be and clock drift De at the clock time t=0 are used for the initial values indicated in Expressions (16), (17). The initial values may be reset as t=0 at a predetermined time point. The predetermined time point may be every predetermined time interval. As indicated below, a time point for resetting the initial values may be determined using as a determination reference an evaluation value E, which is mentioned below. When the value of the positioning error e described in the first embodiment is small, it can be determined that the reliability of the clock bias Be calculated from the pseudo distances is high. The evaluation value E is used as a determination reference based on Expression (10) for calculating the positioning error.

With reference to FIG. 10, the following explains a routine of a Kalman filter initial value reset process.

At S700, calculated evaluation values E are acquired in time series and it is determined whether a duration for which the evaluation value E continues to be less than a reference value th is equal to or greater than a predetermined time (T seconds). When the duration is equal to or greater than T seconds, the processing proceeds to S702. When the duration is less than T seconds, the determination at S702 is repeated.

At S702, the initial values of the Kalman filter are reset by setting the value of the present clock bias Be (calculated most recently) to Expression (16) and setting the value of the present clock drift De (calculated most recently) to Expression (17).

As explained above, according to the positioning apparatus of the second embodiment, the reference clock drift is calculated using the Kalman filter from the clock drift calculated based on the Doppler information; the reference clock bias is estimated; and the difference between the clock bias calculated at a time of positioning and the reference clock bias estimated at the time of positioning is used as an evaluation value of the position-fix accuracy. This can suitably calculate an evaluation value in consideration of the drift component of the clock bias without needs of external data, such as autonomous navigation information.

It is noted that the second embodiment explains the case where the reference clock bias is estimated using the Kalman filter. Without need to be limited thereto, the reference clock bias may be estimated from the clock drift calculated based on the Doppler information by using the regression equation described in the first embodiment.

Aspects of the disclosure described herein are set forth in the following clauses.

As an aspect of the present disclosure, a positioning apparatus is provided as follows. A positioning section is configured to calculate a clock bias and a reception position from a pseudo distance outputted from a GPS receiver based on satellite signals from several different satellites for positioning. Here, the pseudo distance containing a clock bias error, and the pseudo distance being from each of the satellites to the reception position. A clock drift calculation section is configured to calculate a clock drift, which indicates a ratio of a time-lapse change in the clock bias based on a plurality of clock biases calculated in a past or Doppler information outputted from the GPS receiver. A clock bias estimation section is configured to estimate a reference clock bias based on a clock drift calculated by the clock drift calculation section. An evaluation value calculation section is configured to calculate an evaluation value for evaluating a calculation accuracy of a reception position calculated by the positioning section based on a difference between a clock bias calculated by the positioning section and a reference clock bias estimated by the clock bias estimation section.

In addition, as an optional aspect of the present disclosure, the positioning apparatus may be provided as follows. An abnormal signal estimation section may be configured to calculate evaluation values with respect to all combinations selecting four or more pseudo distances out of the pseudo distances, and estimate satellite signals, which correspond to pseudo distances of combinations other than a combination having a positioning error being minimum, to be abnormal signals, the positioning error being obtained based on the calculated evaluation values. Thus, an abnormal signal can be estimated by the positioning error obtained based on the evaluation value calculated appropriately; thus, the pseudo distance used for positioning can be selected appropriately.

In addition, as a further optional aspect of the present disclosure, the positioning apparatus may be provided as follows. An output section may be configured to output as an optimal positioning value one of a GPS positioning value calculated based on the pseudo distances of the combination having the positioning error being minimum and a GPS positioning value obtained by an amendment based on a difference between (i) a distance from the reception position to a satellite, the distance which is calculated based on the pseudo distances of the combination having the positioning error being minimum and (ii) a distance from a reception position to a satellite, the distance which is calculated based on pseudo distances of a combination containing a pseudo distance obtained by a satellite signal, which is estimated to be an abnormal signal by the abnormal signal estimation section. Thus, a positioning result can be optimized by using the positioning error obtained based on the evaluation value calculated appropriately.

As explained above, according to the positioning apparatus of the present disclosure, an advantage can be provided which allows an appropriate evaluation of a position-fix accuracy without needing external data such as autonomous navigation information. Such an advantage may be provided by a positioning method, which is supposed to be used in the above positioning apparatus, and its related program product.

It will be obvious to those skilled in the art that various changes may be made in the above-described embodiments of the present invention. However, the scope of the present invention should be determined by the following claims.

1. A positioning apparatus comprising:
a positioning section configured to calculate a clock bias and a reception position from a pseudo distance outputted from a GPS receiver based on satellite signals from several different satellites for positioning,
the pseudo distance containing a clock bias error,
the pseudo distance being from each of the satellites to the reception position;
a clock drift calculation section configured to calculate a clock drift, which indicates a ratio of a time-lapse change in the clock bias based on a plurality of clock biases calculated in a past or Doppler information outputted from the GPS receiver;
a clock bias estimation section configured to estimate a reference clock bias based on a clock drift calculated by the clock drift calculation section; and
an evaluation value calculation section configured to calculate an evaluation value for evaluating a calculation accuracy of a reception position calculated by the positioning section based on a difference between a clock bias calculated by the positioning section and a reference clock bias estimated by the clock bias estimation section.

2. The positioning apparatus according to claim 1, further comprising:
an abnormal signal estimation section configured to
calculate evaluation values with respect to all combinations selecting four or more pseudo distances out of the pseudo distances, and
estimate satellite signals, which correspond to pseudo distances of combinations other than a combination having a positioning error being minimum, to be abnormal signals, the positioning error being obtained based on the calculated evaluation values.

3. The positioning apparatus according to claim 2, further comprising:
an output section configured to output as an optimal positioning value one of
a GPS positioning value calculated based on the pseudo distances of the combination having the positioning error being minimum and
a GPS positioning value obtained by an amendment based on a difference between (i) a distance from the reception position to a satellite, the distance which is calculated based on the, pseudo distances of the combination having the positioning error being minimum and (ii) a distance from a reception position to a satellite, the distance which is calculated based on pseudo distances of a combination containing a pseudo distance obtained by a satellite signal, which is estimated to be an abnormal signal by the abnormal signal estimation section.

4. A positioning method comprising;
calculating a clock bias and a reception position from a pseudo distance outputted from a GPS receiver based on satellite signals from several different satellites for positioning, the pseudo distance containing a clock bias error, the pseudo distance being from each of the satellites to the reception signal;
calculating a clock drift, which indicates a ratio of a time-lapse change in the clock bias based on a plurality of clock biases calculated in a past or Doppler information outputted from the GPS receiver;
estimating a reference clock bias based on the calculated clock drift; and
calculating an evaluation value for evaluating a calculation accuracy of the reception position based on a difference between the calculated clock bias and the estimated reference clock bias.

5. A program product stored in a computer readable storage medium comprising instructions for execution by a computer, the instructions including the method according to claim 4, which is computer-implemented.
